(19) United States
(12) Patent Application Publication
(10) Pub. No.: US 2013/0258327 A1
(43) Pub. Date: Oct. 3, 2013

(54) METHOD AND APPARATUS FOR INSPECTING SURFACE OF A SAMPLE

(71) Applicant: HITACHI HIGH-TECHNOLOGIES CORPORATION, Tokyo (JP)

(72) Inventors: Yu KUSAKA, Kamisato-machi (JP); Toshiaki SUGITA, Kamisato-machi (JP); Shigeru SERIKAWA, Kamisato-machi (JP)

(73) Assignee: HITACHI HIGH-TECHNOLOGIES CORPORATION, Tokyo (JP)

(21) Appl. No.: 13/758,301

(22) Filed: Feb. 4, 2013

(30) Foreign Application Priority Data
Mar. 28, 2012 (JP) 2012-074840

(51) Int. Cl. G01N 21/95

(52) U.S. Cl. CPC G01N 21/95
USPC 356/237.2

(57) ABSTRACT

In order to feed back information on the detected defect to a production process in a short period of time, there is provided a method for inspecting the surface of a sample by illuminating illumination light to the sample, detecting scattered light generated from the sample by the illumination light and processing a detection signal representing the detected scattered light in order to detect a defect on the sample. In the step of processing the detected scattered signal includes the sub-steps of making use of detection signals representing the scattered light scattered in the first elevation-angle direction and the scattered light scattered in the third elevation-angle direction in order to detect a defect on the sample, identifying the type of the detected defect, generating spectroscopic data by dispersing the scattered light scattered in the second elevation-angle direction and summing up the spectroscopic data for every defect type.

### BACKGROUND OF THE INVENTION

In general, the present invention relates to a method for inspecting a magnetic disc substrate and a semiconductor substrate for a defect and also relates to an apparatus adopting the method. More particularly, the present invention relates to a substrate-surface inspection method proper for detecting a small defect existing on the surface of a substrate and relates to an apparatus adopting the method.

A magnetic head is used for writing data onto a magnetic disc substrate rotating at a high speed and reading out data from the magnetic disc substrate. With the recording density of the magnetic disc substrate becoming higher, a flying height representing the floating distance of the magnetic head from the surface of the magnetic disc substrate becomes very short. The flying height has a typical value in a range of approximately 10 nm to several tens of nm.

Thus, if a defect such as a large fine protrusion having a length greater than the flying height of the magnetic head, an injury or a foreign substance like a dust exists on the surface of the magnetic disc, in an operation to write data on the magnetic disc or read out data from the magnetic disc, the magnetic head collides with the defect, causing a crush phenomenon to occur. A crush phenomenon in turn inevitably causes the magnetic disc apparatus to fail.

In order to produce a magnetic disc apparatus in a stable manner by preventing a defect from existing on the surface of the magnetic disc as a defect that can cause a failure of the magnetic disc apparatus as described above, in a process of manufacturing the magnetic disc apparatus, it is necessary to monitor the state of generation of a defect on the surface of the magnetic disc and to feed back the result of the monitoring to the manufacturing process.

A defect generated on the surface of a magnetic disc during the manufacturing process can be, among others, a crystal defect of the material of the disc substrate, an abrasive grain left by a polishing work carried out in order to flatten the surface of the magnetic disc, a small injury (or a scratch) on the surface of the magnetic disc or a foreign substance (such as a dust) attached to the surface of the magnetic disc.

A method for detecting these defects existing on the surface of a magnetic disc and the configuration of the method are disclosed in patent reference 1 which is Japanese Patent Laid-open No. 2010-236985. In accordance with the disclosed method, there is provided a configuration in which light is radiated to the surface of a magnetic disc in an inclined direction and the light scattered from the surface is detected by 2 scattered-light detecting optical systems provided at elevation angles different from each other. Then, signals obtained as a result of the detection are processed and compared with each other in order to determine the unevenness of a small defect.

In addition, as disclosed in patent reference 2 which is JP-T-2004-529327, a laser beam is radiated to the surface of a substrate and light included in the reflected light (or the scattered light) coming from the surface as light incident to an optical fiber is guided to a diffraction lattice in order to disperse the light entering the optical fiber. In this way, the radiated light can be detected by dividing the light into scattered light based on light having the same wavelength as that of the radiated light and Raman scattered light based on light having a wavelength different from that of the radiated light.

On top of that, patent reference 3 which is JP-T-2009-14510 describes an inspection apparatus which includes an optical system for detecting Rayleigh scattered light and an optical system for detecting Raman scattered light. This reference describes an operation to detect the Rayleigh scattered light and an operation to detect the Raman scattered light as operations carried out separately. This reference also describes the operation to detect the Rayleigh scattered light and the operation to detect the Raman scattered light as operations carried out at the same time. In addition, this reference also describes an operation to create a map for the intensities of the Raman scattered light from results of the detection of the Raman scattered light and display the map. The map shows, among others, physical-property information and composition information.

### SUMMARY OF THE INVENTION

As described above, in order to produce magnetic discs in a stable manner, it is necessary to monitor the state of generation of a defect on the surface of a magnetic disc during a process of manufacturing the disc and feed back the result of the monitoring to the manufacturing process. If the information fed back to the manufacturing process includes information on the composition of a defect in addition to information on distribution of the generated defects and information on the size of each defect, it is possible to easily identify a process causing the defects to be generated. Information on the identified process causing the defects to be generated is effective for producing magnetic discs in a stable manner.

In an operation to optically detect a defect on a substrate, the size of the defect to be detected may be small and may be sufficiently smaller than the wavelength of light radiated to the substrate. In the case of a defect having such a small size to serve as a defect to which illumination light is radiated, Rayleigh scattering may be generated from the defect. In addition, at that time, as Raman scattering, it is known that scattered light is also generated to have a wavelength different from the wavelength of the illumination light in accordance with the material of the defect. The intensity of the Raman scattered light is very small in comparison with the Rayleigh scattered light. However, information obtained by detecting the Raman scattered light as information on the material of the defect is effective for identifying the cause of the detected defect by identifying the composition of the defect and effective for identifying the process in which the defect has been generated. In addition, the information is also important for producing magnetic discs having a higher recording density in a stable manner.

In order to detect this Raman scattered light, it is important to provide a configuration in which the detection optical system includes a spectroscope and a light component having a wavelength different from the wavelength of the illumination light is separated and detected.

A Raman-light analyzing apparatus for detecting and analyzing Raman light is available in the market. However, this Raman-light analyzing apparatus is appropriate for analyzing a relatively large area of a sample. Since the apparatus provided by the present invention is an apparatus for inspecting a defect of the order of nm, nevertheless, the Raman-light analyzing apparatus is inappropriate for analyzing such a defect. In addition, the analysis time required by the Raman-light analyzing apparatus is long so that the Raman-light analyzing apparatus is also inappropriate for use on a manufacturing line of the magnetic disc.

On the other hand, the inspection apparatus disclosed in patent reference 1 has a configuration for detecting the conventional Rayleigh scattered light. In addition, patent reference 1 does not describe operations carried out to detect Raman scattered light and analyze the composition of a defect.

Patent reference 2 describes an example of applying a Raman-light analysis to an inspection apparatus. In accordance with this example, light reflected from a substrate is received by an optical fiber and analyzed by a diffraction device. Then, the light obtained as a result of the analysis is divided into Rayleigh scattered light based on light having the same wavelength as that of the radiated light and Raman scattered light based on light having a wavelength different from that of the radiated light. Subsequently, the Rayleigh scattered light and the Raman scattered light are detected separately from each other. However, the scattered light to be detected is only light incident to an optical fiber provided in one elevation-angle direction. That is to say, patent reference 2 does not describe detection of light scattered in different elevation-angle directions. In general, the way in which scattered light (that is, the Rayleigh scattered light) is generated varies in accordance with the shape of the defect on the substrate and the size of the defect. For example, the defect on the substrate can have a dent shape or a protrusion shape. Thus, it is known that, by carrying out processing by making use of signals detected in different elevation-angle directions, the shape of the defect and the size thereof can be classified more finely into categories. In the configuration described in patent reference 2, however, the scattered light to be detected is only light scattered from the substrate in one elevation-angle direction. Patent reference 2 does not describe the fact that the shape of the defect and the size thereof can be classified more finely into categories by making use of signals obtained as a result of detection of light scattered in different elevation-angle directions.

In addition, patent reference 3 discloses an inspection apparatus including an optical system for detecting Rayleigh scattered light and an optical system for detecting Raman scattered light. Patent reference 3 also describes an operation to detect the Rayleigh scattered light and an operation to detect the Raman scattered light as operations carried out separately. In addition, this reference also describes the operation to detect the Rayleigh scattered light and the operation to detect the Raman scattered light as operations carried out at the same time. However, the reference does not describe an operation to analyze components of individual defects by detection of the Raman scattered light. In addition, the reference also does not describe both a configuration and means which are used for detecting the Raman scattered light having a scattered-light intensity lower than the Rayleigh scattered light when the operation to detect the Rayleigh scattered light and the operation to detect the Raman scattered light are carried out at the same time.

It is thus an object of the present invention addressing the problems of the conventional technologies described above to present a method and an apparatus which are used for inspecting the surface of a substrate by allowing a cause of generation of a defect to be fed back to a production process in a short period of time so as to be able to more finely classify the shape of a detected defect and the size thereof into categories and able to obtain information on the material of the defect right after the defect inspection.

In order to solve the problems of the conventional technologies described above, the present invention provides an apparatus used for inspecting the surface of a substrate serving as a sample and provided with: a rotation driving unit used for mounting the sample, rotating the sample and moving the sample in a direction perpendicular to the rotation axis; an illumination-light emitting unit for illuminating illumination light to the sample mounted on the rotation driving unit; a scattered-light detecting unit for detecting scattered light generated from the sample illuminated by the illumination light emitted from the illumination-light emitting unit; and a signal processing unit for processing a detection signal output by the scattered-light detecting unit to represent the scattered light detected by the scattered-light detecting unit in order to detect a defect on the sample, wherein the scattered-light detecting unit includes: a first scattered-light detecting section for detecting scattered light scattered in a first elevation-angle direction as part of the scattered light generated from the sample illuminated by the illumination light emitted from the illumination-light emitting unit; a second scattered-light detecting section for blocking light having the same wavelength as the wavelength of the illumination light radiated by the illumination-light radiating unit to the sample to remove blocked part of scattered light scattered in a second elevation-angle direction as part of the scattered light generated from the sample illuminated by the illumination light and for dispersing unblocked scattered light in order to detect the unblocked scattered light as dispersed light; and a third scattered-light detecting section for detecting scattered light scattered in a third elevation-angle direction as part of the scattered light generated from the sample illuminated by the illumination light emitted from the illumination-light emitting unit; and the signal processing unit detects a defect on the sample by making use of a detection signal output from the first scattered-light detecting section to represent the scattered light scattered in the first elevation-angle direction and detected by the first scattered-light detecting section and making use of a detection signal output from the third scattered-light detecting section to represent the scattered light scattered in the third elevation-angle direction and detected by the third scattered-light detecting section; determines the position of the detected defect and stores information on the position; identifies the type of the detected defect; receives a detection signal from the second scattered-light detecting section as a signal representing spectroscopic data generated by the second scattered-light detecting section by dispersing the scattered light scattered in the second elevation-angle direction and detected by the second scattered-light detecting section; and sums up the spectroscopic data for every identified defect type.

In addition, in order to solve the problems of the conventional technologies described above, the apparatus provided by the present invention to serve an apparatus used for inspecting the surface of a substrate serving as a sample is further provided with: a display unit for displaying information on defects detected by the signal processing unit; and a control unit for controlling the rotation driving unit, the illumination-light emitting unit, the scattered-light detecting unit, the signal processing unit and the display unit, wherein, with a specified defect included in the defects detected by the signal processing unit as defects on the sample and displayed on the display unit as a specified defect on the screen, the control unit controls the rotation driving unit by making use of the stored information on the position of the specified defect displayed on the display unit in order to move the specified defect to a position illuminated by the illumination light emitted from the illumination-light emitting unit; controls the illumination-light emitting unit in order to illuminate the illumination light to the moved defect; controls the signal processing unit to process a detection signal, which is obtained as a result of processing carried out by the second scattered-light detecting section to disperse scattered light received from the sample having the specified defect illuminated by the illumination light, in order to determine the composition of the specified defect; and displays information on a result of the determination of the composition on the display unit.

In addition, in order to solve the problems of the conventional technologies described above, the present invention provides a method for inspecting the surface of a substrate serving as a sample by execution of the steps of: illuminating illumination light to the sample while rotating the sample and moving the sample in a direction perpendicular to the rotation axis; detecting scattered light generated from the sample illuminated by the illumination light; and processing a detection signal representing the detected scattered light in order to detect a defect on the sample, wherein the step of detecting scattered light includes the sub-steps of: detecting scattered light scattered in a first elevation-angle direction as part of the scattered light generated from the sample illuminated by the emitted illumination light; blocking light having the same wavelength as the wavelength of the illumination light illuminated to the substrate as blocked part of scattered light scattered in a second elevation-angle direction as part of the scattered light generated from the sample illuminated by the radiated illumination light and dispersing unblocked scattered light in order to detect the unblocked scattered light; and detecting scattered light scattered in a third elevation-angle direction as part of the scattered light generated from the sample illuminated by the illumination light; and the step of processing the detected scattered signal includes the sub-steps of: making use of a detection signal representing the scattered light scattered in the first elevation-angle direction and making use of a detection signal representing the scattered light scattered in the third elevation-angle direction in order to detect a defect on the sample; identifying the type of the detected defect; generating spectroscopic data by dispersing the scattered light scattered in the second elevation-angle direction; and summing up the spectroscopic data for every identified defect type.

In addition, in order to solve the problems of the conventional technologies described above, the method provided by the present invention to serve a method adopted for inspecting the surface of a substrate serving as a sample is implemented by further including the steps of: displaying information on detected defects on a screen; and controlling the step of rotating and moving the sample, the step of illuminating the illumination light, the step of detecting the scattered light, the step of processing a detection signal and the step of displaying information, wherein, with a specified defect included in defects detected on the sample and displayed on the screen as a specified defect on the screen, the controlling step is carried out by execution of the sub-steps of: controlling the position of the sample by making use of the stored information on the position of the specified defect in order to move the specified defect to a position illuminated by the radiated illumination light; illuminating the illumination light to the moved defect; processing a detection signal, which is obtained as a result of processing carried out to disperse scattered light scattered in the second elevation-angle direction as part of scattered light received from the sample having the specified defect illuminated by the illumination light, in order to determine the composition of the specified defect; and displaying information on a result of the determination on the screen.

In a substrate-surface inspecting method and a substrate-surface inspecting apparatus which are provided in accordance with the present invention, the shape of a defect and the size thereof are classified more finely and a cause of generation of the defect can be fed back to a production process in a short period of time so that information on the material of the detected defect can be obtained right after the inspection of the defect.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing the entire configuration of a substrate-surface inspecting apparatus according to an embodiment of the present invention;

FIG. 2 is a diagram showing the top view of an optical detection system 100 employed in the substrate-surface inspecting apparatus according to the embodiment of the present invention;

FIG. 3 is a cross-sectional diagram showing a partial configuration of a second elevation-angle detecting unit 120 included in the optical detection system 100 employed in the substrate-surface inspecting apparatus according to the embodiment of the present invention;

FIG. 4 is a flowchart representing the procedure of substrate-surface inspection carried out in accordance with the embodiment of the present invention;

FIG. 5 is a front-view diagram showing a screen displaying results of the substrate-surface inspection carried out in accordance with the embodiment of the present invention;

FIG. 6 is a flowchart representing a procedure of determining the composition of a defect detected by measuring Raman scattered light in accordance with the embodiment of the present invention; and

FIG. 7 is a front-view diagram showing a screen displaying results of defect inspection carried out in accordance with the embodiment of the present invention.

### DESCRIPTION OF THE PREFERRED EMBODIMENTS

Embodiments of the present invention are described by referring to diagrams as follows.

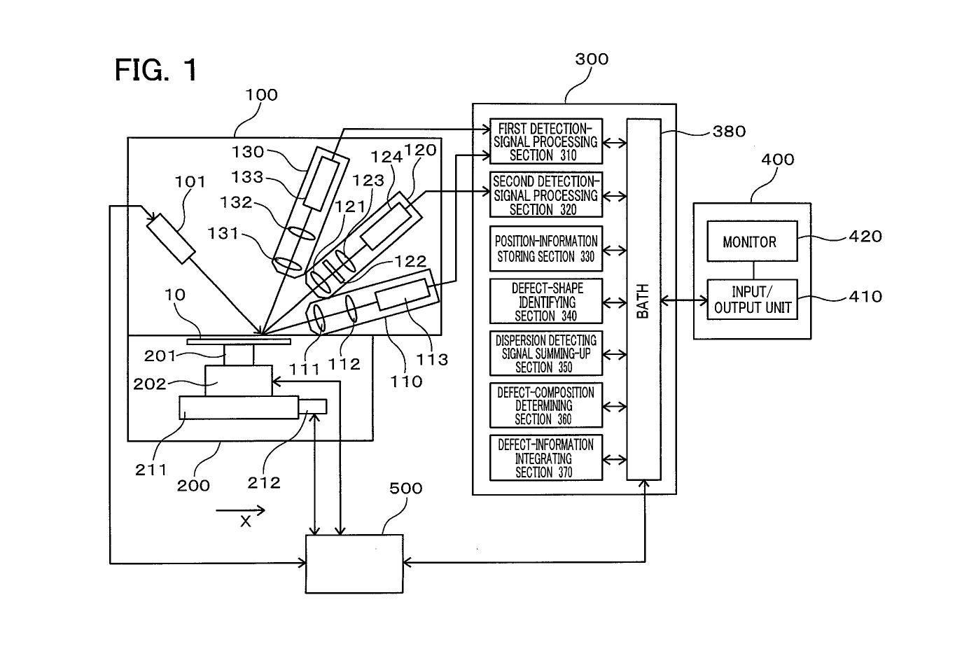

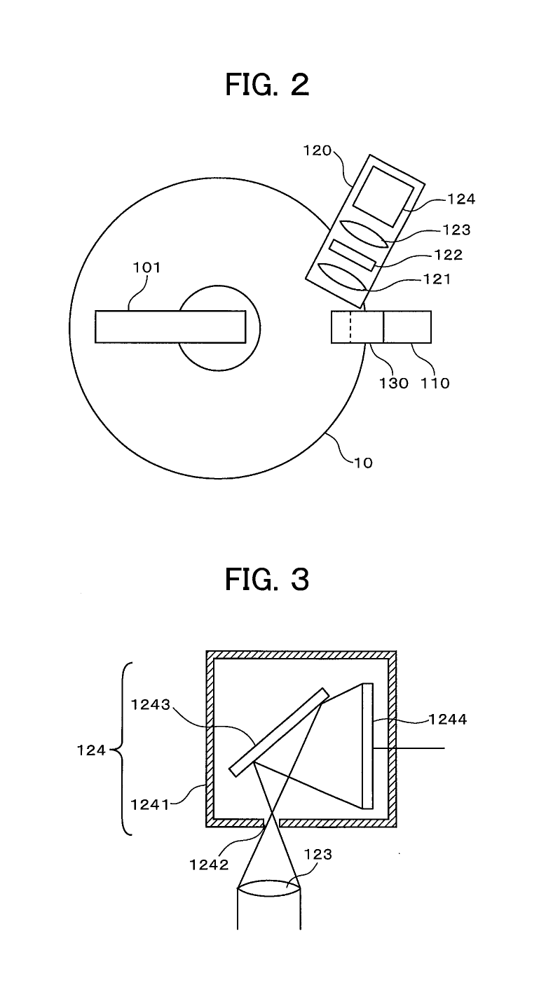

FIG. 1 is a block diagram showing the entire configuration of a substrate-surface inspecting apparatus 1 according to an embodiment of the present invention whereas FIG. 2 is a diagram showing the top view of an optical detection system 100 employed in the substrate-surface inspecting apparatus 1.

As shown in FIG. 1, the substrate-surface inspecting apparatus 1 includes an optical detection system 100, a sample-rotation driving system 200, a signal processing/analyzing system 300, an input/output system 400 and a control system 500.

Also as shown in FIG. 1, the optical detection system 100 includes a laser-beam source 101, a first elevation-angle detecting unit 110, a second elevation-angle detecting unit 120 and a third elevation-angle detecting unit 130.

Also as shown in FIG. 1, the first elevation-angle detecting unit 110 includes an object lens 111, a light converging lens 112 and a photosensor 113 whereas the second elevation-angle detecting unit 120 includes an object lens 121, a wavelength selecting filter 122, a light converging lens 123 and a spectrum detector 124. On the other hand, the third elevation-angle detecting unit 130 includes an object lens 131, a light converging lens 132 and a photosensor 133.

As shown in the top-view diagram of FIG. 2, in the optical detection system 100, the first elevation-angle detecting unit 110 and the third elevation-angle detecting unit 130 are provided at positions at which front scattered light generated from a defect on a sample 10 is detected. That is to say, the first elevation-angle detecting unit 110 and the third elevation-angle detecting unit 130 are provided in the same azimuth-angle direction relative to a direction in which a laser beam is emitted from the laser-beam source 101. The first elevation-angle detecting unit 110 and the third elevation-angle detecting unit 130 are each a section for detecting Rayleigh scattered light coming from the sample 10 to which a laser beam having a single wavelength is illuminated by the laser-beam source 101. In the configuration shown in FIG. 1, the first elevation-angle detecting unit 110 and the third elevation-angle detecting unit 130 employ the object lens 111 and the object lens 131 respectively.

On the other hand, the second elevation-angle detecting unit 120 employs the object lens 121 having an NA (numerical aperture) larger than those of the object lens 111 and the object lens 131 employed in the first elevation-angle detecting unit 110 and the third elevation-angle detecting unit 130 respectively because the second elevation-angle detecting unit 120 is used for detecting Raman scattered light having a strength smaller than Rayleigh scattered light. Thus, in order to get rid of interferences with the first elevation-angle detecting unit 110 and the third elevation-angle detecting unit 130, the second elevation-angle detecting unit 120 is provided at a position shifted from the first elevation-angle detecting unit 110 and the third elevation-angle detecting unit 130. That is to say, the second elevation-angle detecting unit 120 is provided in an azimuth-angle direction different from that of the first elevation-angle detecting unit 110 and the third elevation-angle detecting unit 130.

In order to make explanation of the configuration of the optical detection system 100 easy to understand, FIG. 1 shows the first elevation-angle detecting unit 110, the second elevation-angle detecting unit 120 and the third elevation-angle detecting unit 130 which have about the same size are provided on the same plane. In actuality, however, the second elevation-angle detecting unit 120 is provided at a position shifted from the first elevation-angle detecting unit 110 and the third elevation-angle detecting unit 130 as shown in FIG. 2.

FIG. 3 shows the light converging lens 123 employed in the second elevation-angle detecting unit 120 and details of the spectrum detector 124 also employed in the second elevation-angle detecting unit 120. As shown in the figure, the spectrum detector 124 includes a case section 1241 protecting the inside of the spectrum detector 124 from external light, a pin hole 1242 provided on the case section 1241, a spectroscope 1243 for dispersing incident light propagating to the inside of the spectrum detector 124 through the pin hole 1242 and a detector 1244 for detecting each light beam dispersed by the spectroscope 1243.

In the second elevation-angle detecting unit 120, the object lens 121 converges Raman scattered light coming from the sample 10 into parallel light beams. The wavelength selecting filter 122 then filters out components having the same wavelength as that of the single-wavelength laser beam serving as illumination light from the parallel light beams. Afterwards, the light converging lens 123 converges light output from the wavelength selecting filter 122 on the position of the pin hole 1242. Light passing through the pin hole 1242 then arrives at the spectroscope 1243. The detector 1244 for detecting each light beam dispersed by the spectroscope 1243 makes use of an array sensor such as a CCD or APD array or a photodiode array.

As shown in FIG. 1, the sample-rotation driving system 200 includes a rotatable rotation shaft section 201 on which the sample 10 is mounted, a rotation-shaft driving motor 202 for driving the rotation shaft section 201 into rotation, a reciprocally movable table 211 which can be moved back and fourth in a direction as a table on which the rotation shaft section 201 and the rotation-shaft driving motor 202 are mounted and a table driving motor 212 for driving the reciprocally movable table 211 back and fourth in the direction. In addition, the sample-rotation driving system 200 also includes a detection unit for detecting the rotation angle of the rotation shaft section 201 and the position of the reciprocally movable table 211 and supplying results of the detection to the control system 500. It is to be noted that this detection unit is not shown in the figure.

The signal processing/analyzing system 300 includes a first detection-signal processing section 310 for processing signals, which have been detected by the photosensor 113 and the photosensor 133, in order to detect a defect; a second detection-signal processing section 320 for processing a signal, which has been detected by the spectrum detector 124, in order to obtain a dispersion detecting signal of a defect; and a position-information storing section 330 used for storing information on the rotation angle of the rotation shaft section 201 and information on the position of the reciprocally movable table 211. The signal processing/analyzing system 300 further includes a defect-shape identifying section 340 for determining the shape of a defect on the basis of the detection signals output from the photosensor 113 and the photosensor 133 as signals representing a defect to be detected by the first detection-signal processing section 310 and defect-position information stored in advance in the position-information storing section 330 and for storing defect-shape information along with the defect-position information; a dispersion detecting signal summing-up section 350 for summing up the dispersion detecting signals each detected by the second detection-signal processing section 320 for a defect position on the basis of the position information for each type of the defect shape determined by the defect-shape identifying section 340; and a defect-composition determining section 360 for extracting defect-composition information from the dispersion detecting signals summed up by the dispersion detecting signal summing-up section 350. The signal processing/analyzing system 300 still further includes a defect-information integrating section 370 for integrating the defect information obtained as a result of the determination carried out by the defect-shape identifying section 340 and stored along with the position information with the defect-composition information extracted by the defect-composition determining section 360; and a bus 380 for connecting together the first detection-signal processing section 310, the second detection-signal processing section 320, the position-information storing section 330, the defect-shape identifying section 340, the dispersion detecting signal summing-up section 350, the defect-composition determining section 360 and the defect-information integrating section 370, which are employed in the signal processing/analyzing system 300.

The input/output system 400 includes an input/output unit 410 and a monitor 420. The input/output unit 410 is a section for exchanging signals with the first detection-signal processing section 310, the second detection-signal processing section 320, the position-information storing section 330, the defect-shape identifying section 340, the dispersion detecting signal summing-up section 350, the defect-composition determining section 360 and the defect-information integrating section 370, which are employed in the signal processing/analyzing system 300, through the bus 380. On the other hand, the monitor 420 is a section for displaying information on a screen. The displayed information includes information supplied from the input/output unit 410 to the signal processing/analyzing system 300 and information output from the signal processing/analyzing system 300 to the input/output unit 410.

The control system 500 controls the operation carried out by the laser-beam source 101 of the optical detection system 100 to emit a laser beam. The control system 500 also controls the driving of the rotation-shaft driving motor 202 and the table driving motor 212 which are employed in the sample-rotation driving system 200. In addition, the control system 500 also extracts the rotation angle of the rotation shaft section 201 and the position information of the reciprocally movable table 211. On top of that, the control system 500 also controls the signal processing/analyzing system 300 and the input/output system 400.

Next, the following description explains operations carried out by the substrate-surface inspecting apparatus 1 having the configuration described above.

As described above, the control system 500 controls the driving of the rotation-shaft driving motor 202 and the table driving motor 212 in order to continuously move the rotation shaft section 201 in one direction while rotating the rotation shaft section 201 on which the sample 10 has been mounted. In this condition, the laser-beam source 101 emits a laser beam and illuminates the laser beam to the surface of the rotating sample 10. From the surface of the sample 10 to which the laser beam is being illuminated generates scattered light according to the state of the surface of the sample 10. That is to say, if the surface of the sample 10 is an ideal flat surface, the surface of the sample 10 to which the laser beam is being illuminated generates only normally reflected light. If the surface of the sample 10 has a defect, on the other hand, the defect causes the generation of scattered light. Examples of the defect are a groove defect (or a scratch which is a dent defect) caused by a small injury, a bump defect (or a protrusion defect), an abrasive grain (a protrusion defect) left by a polishing work and a foreign substance (a protrusion defect) originated by an external source and attached to the surface of the sample 10.

The scattered light is generated from a defect in different directions depending on the shape of the defect and the size thereof. In the case of a groove defect (or a scratch which is a dent defect) for example, the scattered light generated from the defect has an intensity distribution of relatively strong light propagating in the upward direction. In the case of a bump defect (or a protrusion defect), an abrasive grain (a protrusion defect) left by a polishing work or a foreign substance (a protrusion defect) originated by an external source and attached to the surface of the sample 10, on the other hand, the scattered light emitted from the defect has a relatively isotropic distribution.

The scattered light emitted from a defect on the sample 10 includes light which is scattered in a direction to the first elevation-angle detecting unit 110 and arrives at the object lens 111 as incident light. This incident light is converged by the light converging lens 112 and detected by the photosensor 113. The photosensor 113 employs a photomultiplier tube or an APD (avalanche photodiode). In addition, the scattered light generated from the defect on the sample 10 also includes light which is scattered in a direction to the third elevation-angle detecting unit 130 and arrives at the object lens 131 as incident light. By the same token, this incident light is converged by the light converging lens 132 and detected by the photosensor 133. The photosensor 133 employs a photomultiplier tube or an APD.

A detection signal output from the photosensor 113 to represent the scattered light is supplied to the first detection-signal processing section 310 employed in the signal processing/analyzing system 300. By the same token, a detection signal output from the photosensor 133 to represent the scattered light is also supplied to the first detection-signal processing section 310. The first detection-signal processing section 310 saves the detection signals supplied thereto as position information detected by the photosensor 113 and the photosensor 133.

The defect-shape identifying section 340 compares the detection signal output from the photosensor 113 with the detection signal output from the photosensor 133. If the detection signal output from the photosensor 113 and the detection signal output from the photosensor 133 have the same level, the defect is determined to be a protrusion defect. If the detection signal output from the photosensor 113 has a level lower than the level of the detection signal output from the photosensor 133, on the other hand, the defect is determined to be a groove defect (or a scratch which is a dent defect). In addition, on the assumption that the level of the detection signal for a defect is proportional to the size of the defect, on the basis of the levels of the detection signals for determined defects, the sizes of defects are classified into a large size, a medium size and a small size. On top of that, by making use of the position information for a detected defect, a defect with a contiguous position (that is, a defect detected throughout several pixel areas) is determined to be one defect whereas, from the horizontal and vertical dimension characteristics of the defect, the defect is determined to be a line-shape defect or a large-area defect. The defect-shape information identified by the defect-shape identifying section 340 and the defect-position information saved in the position-information storing section 330 are supplied to the dispersion detecting signal summing-up section 350.

In addition, the scattered light generated from the defect on the sample 10 also includes light which is scattered in a direction to the second elevation-angle detecting unit 120 and arrives at the object lens 121 as incident light. The wavelength selecting filter 122 such as a dichroic mirror removes a light component having the same wavelength as the illumination light from the incident light and leaves only a Raman scattered light component. In the following description, the light component having the same wavelength as the illumination light is referred to as a Rayleigh scattered light component. Then, the light converging lens 123 converges the light output from the wavelength selecting filter 122 on the position of the pin hole 1242 provided at the case section 1241 employed in the spectrum detector 124. The converged light passes through the pin hole 1242 and is guided to the inside of the case section 1241. Then, the converged light arrives at the spectroscope 1243. The light is dispersed by the spectroscope 1243 and arrives at the detector 1244. A detection signal output from the detector 1244 to represent the dispersed light is supplied to the second detection-signal processing section 320 employed in the signal processing/analyzing system 300 to be processed by the second detection-signal processing section 320.

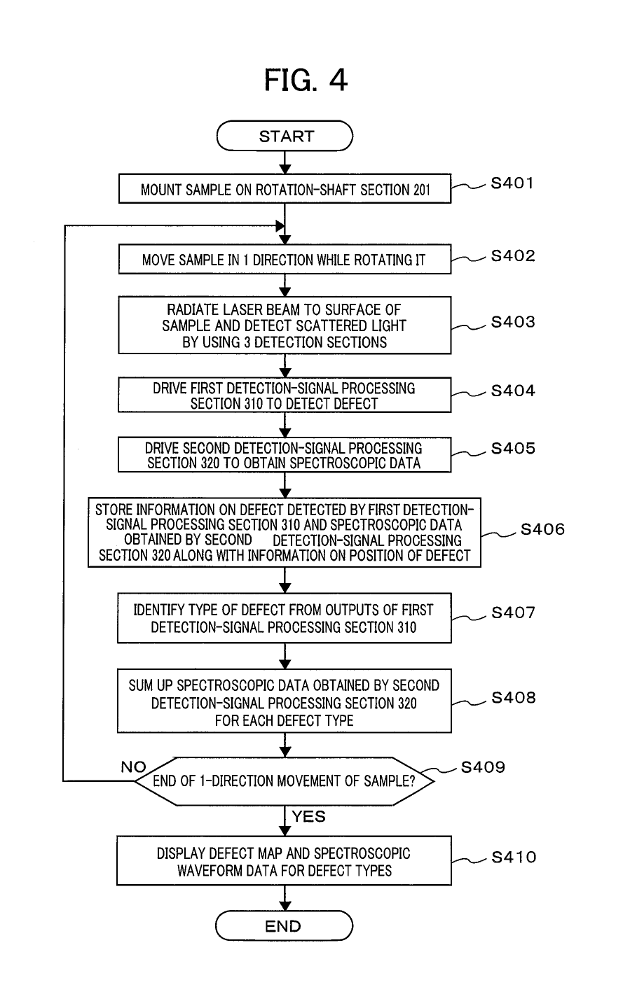

Next, by referring to FIG. 4, the following description explains a procedure carried out to inspect a sample 10 in the configuration described above by referring to FIGS. 1 to 3.

First of all, at a step S401 of a flowchart shown in FIG. 4, the sample 10 to be inspected is mounted on the rotation shaft section 201. Then, at the next step S402, while the rotation-shaft driving motor 202 is rotating the rotation shaft section 201, the table driving motor 212 moves the reciprocally movable table 211 in a direction which is the direction of an arrow X shown in FIG. 1. Subsequently, at the next step S403, the laser-beam source 101 emits a laser beam to illuminate the surface of the sample 10 which is moving in the direction while rotating. So, the surface of the sample 10 generates scattered light to be detected by the first elevation-angle detecting unit 110, the second elevation-angle detecting unit 120 and the third elevation-angle detecting unit 130 which are employed in the optical detection system 100.

Then, at the next step S404, detection signals output by the first elevation-angle detecting unit 110 and the third elevation-angle detecting unit 130 are supplied to the first detection-signal processing section 310 in order for the first detection-signal processing section 310 to detect a defect on the sample 10. Subsequently, at the next step S405, a detection signal output from the second elevation-angle detecting unit 120 is supplied to the second detection-signal processing section 320 in order for the second detection-signal processing section 320 to obtain spectroscopic waveform data from this detection signal. Then, at the next step S406, information on the defect detected at the step S404 and the spectroscopic waveform data obtained at the step S405 for the defect are stored by associating the information on the defect and the spectroscopic waveform data of the defect with information on the position of the defect.

Subsequently, at the next step S407, the type of the defect and the size thereof are identified on the basis of the defect information output from the first detection-signal processing section 310 and the defect-position information stored in the position-information storing section 330. Then, at the next step S408, the spectroscopic waveform data obtained at the step S405 is summed up for every type and every size which are identified for a defect. Subsequently, the processing flow goes on to the next step S409 in order to determine whether or not the movement made by the sample 10 in the direction has been completed. If the determination result is NO indicating that the movement made by the sample 10 in the direction has not been completed, the processing flow goes back to the step S402 in order to continue the inspection.

If the determination result is YES indicating that the movement made by the sample 10 in the direction has been completed, on the other hand, the processing flow goes on to a step S410 in order to display results of the inspection on the screen 500 of the monitor 420 employed in the input/output system 400.

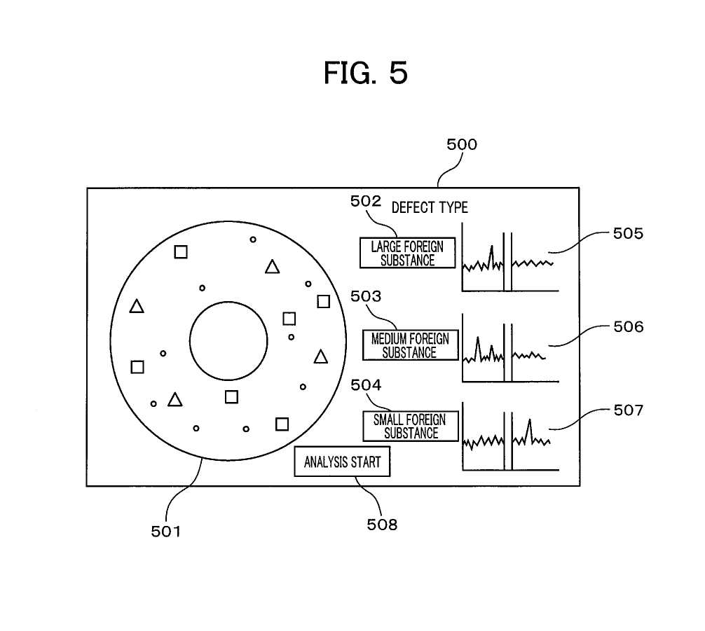

FIG. 5 is a front-view diagram showing the screen 500 of the monitor 420 as a screen displaying typical results of the substrate-surface inspection. The typical results shown in FIG. 5 include a defect map 501, defect types 502 to 504 and waveforms 505 to 507 for the defect types 502 to 504 respectively. The defect map 501 shows a distribution of defects and the types of the defects. Each of the waveforms 505 to 507 is obtained by summing up spectroscopic detection signals for the defect type corresponding to the waveform.

By carrying out the inspection in this way, it is possible to obtain information on the position of a defect by detecting scattered light. In addition, at the same time, it is also possible to determine the shape of each defect and obtain information on the composition of the defect by detecting Raman scattered light. Thus, the information on the composition of the defect can be obtained in an efficient way for every defect type.

In addition, since the Raman scattered light is detected at the same time as an operation to detect a defect by detecting Rayleigh scattered light, the Raman scattered light can be detected all over the sample. Thus, by comparing the information on the compositions of the defects for samples with each other, it is possible to monitor the production process for not only the types of defects, but also the information on the compositions of the defects.

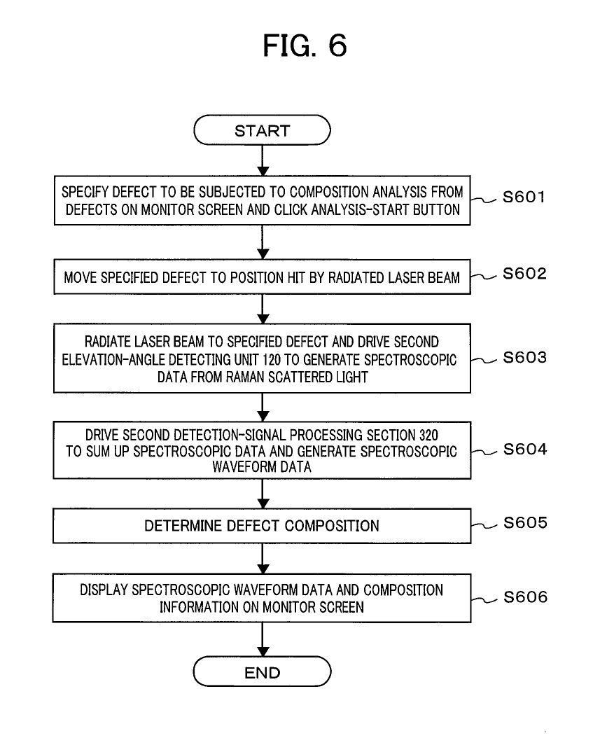

Next, by referring to a flowchart shown in FIG. 6, the following description explains a method for determining the composition of a specified defect by measuring Raman scattered light for the defect from inspection results displayed on the control system 500 of the monitor 420.

First of all, at a step S601 of the flowchart shown in FIG. 6, a defect on the defect map 501 displayed on the control system 500 of the monitor 420 is specified as a defect to be subjected to a composition analysis by clicking the defect on the control system 500. Then, an analysis-start button 508 displayed on the control system 500 is clicked. Subsequently, at the next step S602, the control system 500 reads out information on the position of the specified defect from the position-information storing section 330 and controls the rotation-shaft driving motor 202 as well as the table driving motor 212 in order to drive the rotation-shaft driving motor 202 as well as the table driving motor 212 so as to move the specified defect to a position to which a laser beam is radiated by the laser-beam source 101. Then, at the next step S603, after the specified defect has been moved to the position to which a laser beam is being illuminated from the laser-beam source 101, the control system 500 drives the laser-beam source 101 to emit a laser beam to illuminate the defect existing on the sample 10. Thus, Raman scattered light included in scattered light generated from the illuminated position on the sample 10 is detected by the second elevation-angle detecting unit 120 as spectroscopic light. The illuminated position is the position to which a laser beam is illuminated which is emitted from the laser-beam source 101.

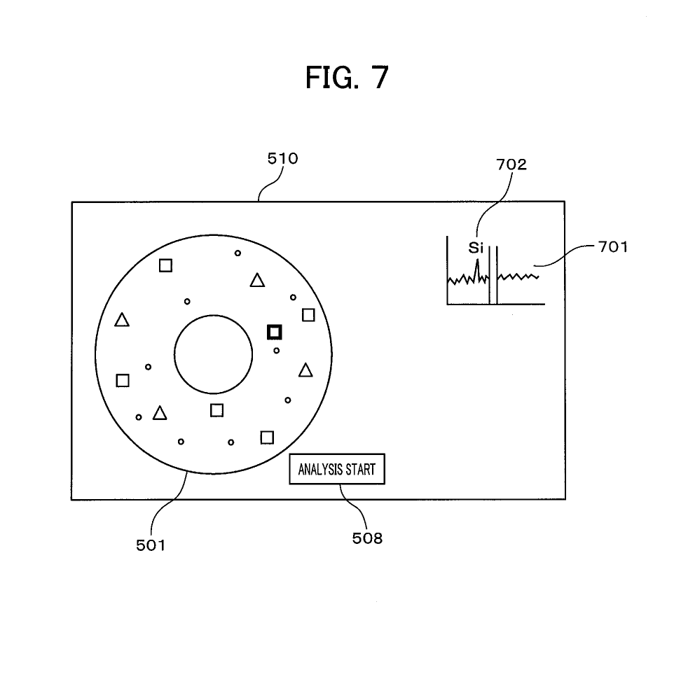

Then, at the next step S604, the second elevation-angle detecting unit 120 supplies a detection signal representing the spectroscopic light to the second detection-signal processing section 320 which receives the detection signal as spectroscopic waveform data. Subsequently, at the next step S605, the second detection-signal processing section 320 supplies the spectroscopic waveform data received from the second elevation-angle detecting unit 120 to the defect-composition determining section 360 though the bus 380. The defect-composition determining section 360 finds a Raman shift quantity from the spectroscopic waveform data and determines the composition of the defect existing on the surface of the sample 10 from a pre-stored relation between the Raman shift quantity and the material. Then, at the next step S606, the spectroscopic waveform data 701 and the determined composition data 702 are displayed on a screen 510 of the monitor 420 as shown in FIG. 7. As described before, the screen 510 also shows the defect map 501.

As described above, in accordance with the embodiment, it is possible to simultaneously detect a defect by detecting Rayleigh scattered light and obtain information on the composition of a defect by detecting Raman scattered light. Thus, information on the composition of a defect can be obtained in an efficient way for every defect type.

In addition, after a defect has been detected, a measurement of a Raman scattered light can be carried out by making use of the information on the position of a detected defect without removing the sample from the rotation shaft section 201. Thus, the composition of a specified defect can be known certainly.

In the above description, the invention discovered by inventors has been exemplified in concrete terms by explaining an embodiment. However, the scope of the present invention is by no means limited to the embodiment. In other words, it is needless to say that a variety of changes can be made to the embodiment as long as the changes are within a range not deviating from essentials of the present invention.

What is claimed is:

1. A substrate-surface inspecting apparatus comprising:
a rotation driving unit used for mounting a sample, rotating said sample and moving said sample in a direction perpendicular to the rotation axis;
an illumination-light emitting unit for illuminating illumination light to said sample mounted on said rotation driving unit;
a scattered-light detecting unit for detecting scattered light generated from said sample illuminated by said illumination light emitted from said illumination-light emitting unit; and
a signal processing unit for processing a detection signal output from said scattered-light detecting unit to represent said scattered light detected by said scattered-light detecting unit in order to detect a defect on said sample,
wherein said scattered-light detecting unit includes:
a first scattered-light detecting section for detecting scattered light scattered in a first elevation-angle direction as part of said scattered light generated from said sample illuminated by said illumination light emitted from said illumination-light emitting unit;
a second scattered-light detecting section for blocking light having the same wavelength as the wavelength of said illumination light emitted from said illumination-light illuminating unit to said sample to remove blocked part of scattered light scattered in a second elevation-angle direction as part of said scattered light generated from said sample illuminated by said illumination light and for dispersing unblocked scattered light in order to detect said unblocked scattered light as dispersed light; and
a third scattered-light detecting section for detecting scattered light scattered in a third elevation-angle direction as part of said scattered light generated from said sample illuminated by said illumination light emitted from said illumination-light emitting unit; and
wherein said signal processing unit
detects a defect on said sample by making use of a detection signal output from said first scattered-light detecting section to represent said scattered light scattered in said first elevation-angle direction and detected by said first scattered-light detecting section and making use of a detection signal output from said third scattered-light detecting section to represent said scattered light scattered in said third elevation-angle direction and detected by said third scattered-light detecting section;
determines the position of said detected defect and stores information on said position;
identifies the type of said detected defect;
receives a detection signal from said second scattered-light detecting section as a signal representing spectroscopic data generated by said second scattered-light detecting section by dispersing said scattered light scattered in said second elevation-angle direction and detected by said second scattered-light detecting section; and
sums up said spectroscopic data for every identified defect type.

2. The substrate-surface inspecting apparatus according to claim 1 wherein, when seen from an on-sample position existing on said sample as a position illuminated by said illumination light, said second scattered-light detecting section is provided at a detection position having an elevation angle greater than the elevation angle of the detection position of said first scattered-light detecting section but smaller than the elevation angle of the detection position of said third scattered-light detecting section.

3. The substrate-surface inspecting apparatus according to claim 1 wherein, when seen from an on-sample position existing on said sample as a position illuminated by said illumination light, said second scattered-light detecting section is provided at a detection position having an azimuth angle different from the elevation angle of the detection position of said first scattered-light detecting section and different from the azimuth angle of the detection position of said third scattered-light detecting section.

4. The substrate-surface inspecting apparatus according to claim 1 wherein
each of said first scattered-light detecting section, said second scattered-light detecting section and said third scattered-light detecting section has an object lens for converging scattered light received from said sample illuminated by said illumination light; and
said object lens of said second scattered-light detecting section has a numerical aperture greater than that of said object lens of said first scattered-light detecting section and greater than that of said object lens of said third scattered-light detecting section.

5. The substrate-surface inspecting apparatus according to claim 1, said substrate-surface inspecting apparatus further comprising:
a display unit for displaying information on defects detected by said signal processing unit; and
a control unit for controlling said rotation driving unit, said illumination-light radiating unit, said scattered-light detecting unit, said signal processing unit and said display unit, wherein,
with a specified defect included in said defects detected by said signal processing unit as defects on said sample and displayed on said display unit as a specified defect on said screen, said control unit
controls said rotation driving unit by making use of said stored information on the position of said specified defect displayed on said display unit in order to move said specified defect to a position illuminated by said illumination light emitted from said illumination-light emitting unit;
controls said illumination-light emitting unit in order to illuminate said illumination light to said moved defect;
controls said signal processing unit to process a detection signal, which is obtained as a result of processing carried out by said second scattered-light detecting section to disperse scattered light received from said sample having said specified defect illuminated by said illumination light, in order to determine the composition of said specified defect; and
displays information on a result of said determination of said composition on said display unit.

6. A substrate-surface inspecting method comprising the steps of:
illuminating illumination light to a sample while rotating said sample and moving said sample in a direction perpendicular to the rotation axis;
detecting scattered light generated from said sample illuminated by said illumination light; and
processing a detection signal representing said detected scattered light in order to detect a defect on said sample, wherein
said step of detecting scattered light includes the sub-steps of:
detecting scattered light scattered in a first elevation-angle direction as part of said scattered light generated from said sample illuminated by said illumination light;
blocking light having the same wavelength as the wavelength of said illumination light illuminated to said sample as blocked part of scattered light scattered in a second elevation-angle direction as part of said scattered light generated from said sample illuminated by said illumination light and dispersing unblocked scattered light in order to detect said unblocked scattered light; and
detecting scattered light scattered in a third elevation-angle direction as part of said scattered light generated from said sample illuminated by said illumination light; and
said step of processing said detected scattered signal includes the sub-steps of:
making use of a detection signal representing said scattered light scattered in said first elevation-angle direction and making use of a detection signal representing said scattered light scattered in said third elevation-angle direction in order to detect a defect on said sample;
identifying the type of said detected defect;
generating spectroscopic data by dispersing said scattered light scattered in said second elevation-angle direction; and
summing up said spectroscopic data for every identified defect type.

7. The substrate-surface inspecting method according to claim 6 wherein, when seen from an on-sample position existing on said sample as a position illuminated by said illumination light, said scattered light scattered in said second elevation-angle direction forms an elevation angle greater than an elevation angle formed by said scattered light scattered in said first elevation-angle direction but smaller than an elevation angle formed by said scattered light scattered in said third elevation-angle direction.

8. The substrate-surface inspecting method according to claim 6 wherein, when seen from an on-sample position existing on said sample as a position illuminated by said illumination light, said scattered light scattered in said second elevation-angle direction forms an azimuth angle different from an azimuth angle formed by said scattered light scattered in said first elevation-angle direction and different from an azimuth angle formed by said scattered light scattered in said third elevation-angle direction.

9. The substrate-surface inspecting method according to claim 6 wherein
each of said scattered light scattered in said first elevation-angle direction, said scattered light scattered in said second elevation-angle direction and said scattered light scattered in said third elevation-angle direction is detected through an object lens for converging scattered light generated from said sample illuminated by said illumination light; and
said object lens provided for said scattered light scattered in said second elevation-angle direction has a numerical aperture greater than that of said object lens provided for said scattered light scattered in said first elevation-angle direction and greater than that of said object lens provided for said scattered light scattered in said third elevation-angle direction.

10. The substrate-surface inspecting method according to claim 6, said substrate-surface inspecting method further comprising the steps of:
displaying information on detected defects on a screen; and
controlling said step of illuminating illumination light to a sample while rotating said sample and moving said sample, said step of detecting scattered light, said step of processing a detection signal and said step of displaying of said information, wherein,
with a specified defect included in defects detected on said sample and displayed on said screen as a specified defect on said screen, said controlling step is carried out by execution of the sub-steps of:
controlling the position of said sample by making use of said stored information on the position of said specified defect in order to move said specified defect to a position illuminated by said illumination light;
illuminating said illumination light to said moved defect;
processing a detection signal, which is obtained as a result of processing carried out to disperse scattered light scattered in said second elevation-angle direction as part of scattered light received from said sample having said specified defect illuminated by said illumination light, in order to determine the composition of said specified defect; and
displaying information on a result of said determination on said screen.
